(19) United States
(12) Patent Application Publication
(10) Pub. No.: US 2015/0088977 A1
(43) Pub. Date: Mar. 26, 2015

(54) WEB-BASED MEDIA CONTENT MANAGEMENT

(71) Applicant: Versigraph Inc., Franklin Square, NY (US)

(72) Inventor: Joshua A. Monesson, Franklin Square, NY (US)

(21) Appl. No.: 14/490,998

(22) Filed: Sep. 19, 2014

Related U.S. Application Data
(60) Provisional application No. 61/880,443, filed on Sep. 20, 2013.

(51) Int. Cl. H04L 29/06; G06F 3/0484; H04L 29/08

(52) U.S. Cl. CPC H04L 65/60; H04L 67/10; G06F 3/0484
USPC 709/203

(57) ABSTRACT

A first media content and a second media content are accessed using a web-based user interface. The first and the second media contents are modified using the web-based user interface to create a third media content that is based on the first and the second media contents. The third media content is transmitted, using the web-based user interface, over a network for presentation on display devices.

### CROSS-REFERENCE TO RELATED APPLICATIONS

This application claims priority to U.S. Application Ser. No. 61/880,443, filed Sep. 20, 2013, the contents of which are incorporated herein by reference in their entirety.

### TECHNICAL FIELD

This disclosure relates to managing media content using web-based tools.

### BACKGROUND

Broadcast media content providers, such as television program producers, generally create, manage and deploy media content using dedicated software tools. These software tools are typically run as dedicated applications on computing devices used by the media content providers.

### SUMMARY

This disclosure describes solutions for creating, managing and deploying media content for delivery to a variety of platforms, such as broadcast television, World Wide Web (web), mobile, and embedded devices. The media content may be created, managed and deployed using technologies like Web Graphics Library (WebGL) that are accessed through Internet browsers. The solutions can be implemented on machines running various operating system software.

In one aspect, a first media content and a second media content are accessed using a web-based user interface. The first and the second media contents are modified using the web-based user interface to create a third media content that is based on the first and the second media contents. The third media content is transmitted, using the web-based user interface, over a network for presentation on display devices.

Particular implementations may include one or more of the following features. Accessing the first and second media contents may comprise accessing at least one of the first and second media contents from a remote server over the network. Accessing the first and second media contents may comprise accessing at least one of the first and second media contents from a local storage coupled to a computing device on which the web-based user interface is executed.

The web-based user interface may be executed on a computing device. The web-based user interface may be presented on a web browser running on the computing device. The web-based user interface may be associated with a Web Graphics Library (WebGL) included in the web browser running on the computing device. The web-based user interface may be coupled to a rendering engine executed on the computing device, the rendering engine operable to utilize WebGL for modifying at least one of the first and the second media contents to create the third media content.

The first media content may include a media stream and the second media content may include a graphics template. Modifying the first and the second media contents to create the third media content may comprise modifying one or more attributes of the graphics template. The modified graphics template may be overlaid on the media stream. The third media content may be generated including the modified graphics template overlaid on the media stream.

The media stream may include a video feed that is obtained from a remote server over the network. The graphics template may be operable to display live information. The live information may be one of a stock ticker, a news feed, weather update, an emergency alert, or broadcast program information.

Transmitting the third media content over the network for presentation on display devices may comprise one of sending the third media content to broadcast television stations, or storing the third media content on a server that is accessible by client devices via the network.

The third media content may be stored in a local storage coupled to a computing device on which the web-based user interface is executed.

Implementations of the above techniques include a method, a system and a computer program product. The system comprises a web-based user interface; a management module including first instructions stored in a first machine-readable medium that, when executed by a first processor, are configured to cause the first processor to perform the above-described operations; a deployment module including second instructions stored in a second machine-readable medium that, when executed by a second processor, are configured to cause the second processor to perform the above-described operations; and means for modifying the first and the second media contents to create the third media content that is based on the first and the second media contents.

The computer program product is implemented in a non-transitory machine-readable medium storing instructions for execution by a processor. The instructions, when executed, are configured to cause the processor to perform the above-described operations.

The details of one or more disclosed implementations are set forth in the accompanying drawings and the description below. Other features, aspects, and advantages will become apparent from the description, the drawings and the claims.

### BRIEF DESCRIPTION OF THE DRAWINGS

FIG. 1 is a block diagram of an example system that may be used for creation and management of media content using web-based technologies.

FIG. 2 illustrates an example user interface showing a creation environment that may be used for web-based media content creation.

FIG. 3 is a block diagram of an example management tool that may be used for managing media content.

FIG. 4 is a block diagram of an example deployment tool that may be used for deploying media content.

FIG. 5 is a flow chart illustrating an example process for the creation and management of media content using web-based technologies.

Like reference symbols in the various drawings indicate like elements.

### DETAILED DESCRIPTION

Software tools for creating, managing and deploying media content have been available for broadcasters and other content providers for a number of years. Real-time rendering technology that had evolved from flight simulators have been incorporated into high-end workstations and software applications were written that allowed for the creation of compositions comprised of graphical elements that can be updated on the fly. The compositions or graphical templates that were built with these software applications would be recalled through companion sequencing applications enabling content production. In these approaches, a template could be created once and reused a number of times throughout a live or pre-taped production. Additional features were built into the software tools to allow for sequencing of these graphical templates, complete with any relevant content germane to the program being produced, so that they could be recalled when requested by the media content director.

However, software tools such as the applications above have not been adapted to take advantage of cutting-edge technologies that are available on the web and elsewhere. For example, real-time rendering technologies are now available for use within an Internet browser (also referred to as a web browser), which may be independent of the underlying operating system platform and can be run on commercial off-the-shelf (COTS) computing devices. The software tools described above are still platform-dependent and are executed on expensive, high-end workstations.

This disclosure describes a content-creation software tool 112 that implements a real-time rendering engine, also referred to as a rendering engine, which generates media content in a web browser using technologies in the host computing devices graphics processing unit (GPU). In this context, the media content may be in the form of on-screen graphics like a stock ticker, weather forecast and mapping imagery, an on-screen interactive presentation and a virtual studio, among others.

In some implementations, the outputted images are generated at a rate of 60 times a second or thereabouts, thereby enabling the software tool 112 to be used interactively with a variety of input devices, such as touchscreens, camera tracking encoders, handheld game controllers (such as 6 DOF controllers), and it can be fed live data for visualization, for example on a display coupled to the host computing device.

In some implementations, the rendering engine is designed to export the generated media content to various outputs, such as a display coupled to the host computing device (for example, via HDMI or DVI) and third party video input/output (I/O) solutions (for example, Matrox or Digital Video Systems). The rendering engine is also capable of accepting incoming video or audio streams, or both, and displaying them within a composition using third party hardware and web coding/decoding modules (codecs).

The content-creation software tool 112 includes components for management and deployment of the media content via the rendering engine. In some implementations, the content-creation software tool 112 employs an asset database that is used to store and recall previously created compositions, graphical elements and audio or video clips, or both. The content-creation software tool 112 can generate content via manual operation or it may be automated and deployed in an unattended fashion.

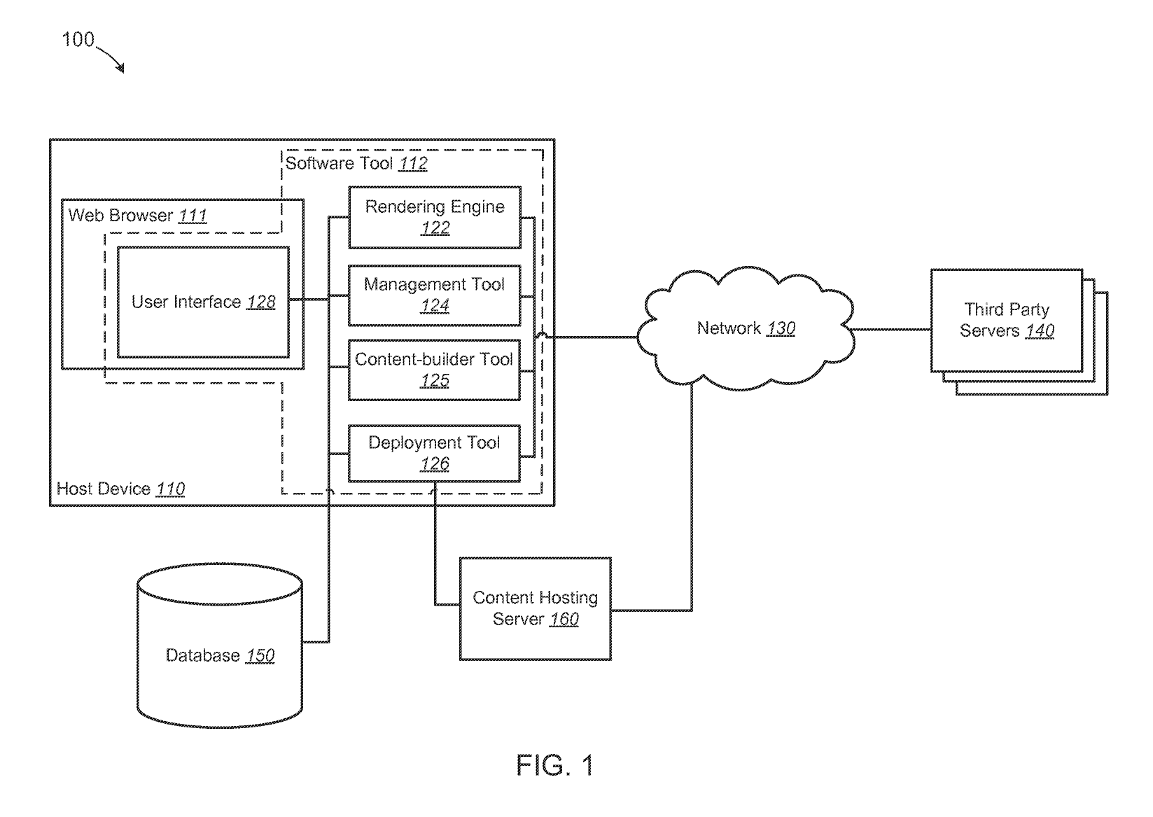

FIG. 1 is a block diagram of an example system 100 that may be used for creation and management of media content using web-based technologies. The system 100 includes a host device 110 that is connected via a network 130 to one or more third party servers 140. Also connected to the host device are a database 150 and a content hosting server 160. Running on the host device is a web browser 111 and a content-creation software tool 112, which comprises a rendering engine 122, a management tool 124, a content-builder tool 125, a deployment tool 126 and a user interface 128.

The host device 110 is an electronic computing device configured with hardware and software that enable the device to interface with a user (for example, a content creator) and run hardware and software applications to perform various processing tasks, including support for media content creation, management and deployment. For example, the host device 110 may be a desktop computer, a workstation, a tablet computer, a notebook computer, a laptop computer, a smartphone, an e-book reader, a music player, an embedded microcontroller, or any other appropriate stationary or portable computing device.

The host device 110 may include one or more processors that are configured to execute instructions stored by computer readable media for performing various operations, such as input/output, communication, data processing, and the like. For example, the host device 110 may include or communicate with a display and may present information to a user through the display. The display may be implemented as a proximity-sensitive or touch-sensitive display (for example, a touch screen) such that the user may enter information by touching or hovering a control object (for example, a finger or stylus) over the display.

The host device 110 is configured to establish communications with other devices and servers across the network 130 that allow the device 110 to transmit and/or receive data, which includes voice, audio, video, graphics and textual data. The host device is also operable to communicate with the database 150 or the media content server 160, or both, for exchanging data that may be used for creating, managing and deploying broadcast media content.

One or more applications that can be executed by the host device 110 allow the device to process the data for use in the creation, management and deployment of broadcast media content. For example, in some implementations, the host device can run a web browser 111 that is operable to present a user interface 128 for a content-creation software tool 112 that implements a real-time rendering engine for generating media content. The web browser may be one of Microsoft Internet Explorer, Mozilla Firefox, Google Chrome, Apple Safari, Opera, Netscape Navigator, or some other suitable web browser.

In some implementations, the web browser 111 is operable to run graphics software such as WebGL, which may be used by the web browser-based content-creation software tool 112 for media content creation, management and deployment. In this context, WebGL includes a JavaScript application programming interface (API) for rendering interactive two-dimensional and three-dimensional graphics within any compatible web browser without the use of plug-ins. WebGL is integrated into all the web standards of the browser 111, allowing GPU-accelerated usage of physics and image processing and effects as part of the web page canvas. WebGL elements can be mixed with other HyperText Markup Language (HTML) elements and composited with other parts of the web page or web page background. In some implementations, the web browser-based content-creation software tool 112 includes control code written in JavaScript and shader code that is executed on the GPU of the host device 110. The software tool 112 may be used to create scenes that are then exported to WebGL. The software tool 112 also may be used to publish interactive three-dimensional content online using WebGL.

As indicated previously, the user interface 128 is one component of the software tool 112. Other components of the software tool 112, such as the rendering engine 122, the management tool 124 and the deployment tool 126, share user interface patterns to provide a consistent user experience. The user interface 128 provide the front end for the software tool 112 and allow the user to access the features of the other components of the software tool 112 that lie within. Once a user has authored his or her content and has published it, the content may be viewed and interacted with via the user interface 128.

In some implementations, the rendering engine 122, which is also known as a game engine, a rendering engine, or by some other suitable nomenclature, is a stand-alone component. In some other implementations the rendering engine is included as part of some other component of the software tool 112. The rendering engine 122 provides visualization of compositions, animation of elements, visual and physical effects and sound effects, among other functions.

In some implementations, the rendering engine 122 has the ability to make socket connections and transfer data asynchronously, allowing it to be deployed in a networked environment. This allows the rendering engine 122 to act on incoming data/messaging and the loading and triggering of any composition that resides in the asset database, such as the database 150.

In some implementations, the software tool 112 may utilize multiple rendering engines in a synchronized fashion, allowing for visualization of complex compositions and datasets across a very large viewing area, such as a video display matrix (also referred to as a video wall).

The management tool 124 offers functionality, which is exposed through the user interface 128, that allows users to establish linkages between elements found in a graphics template (for example, a composition) and data sources. In this manner, elements within a composition may be affected by any changes found in the data stream obtained from the data sources.

The management tool 124 allows importing new assets, such as 2D or 3D geometry, audio clips, video clips, fonts, or images, or any suitable combination of these. In some implementations, users can link their accounts with third party vendors to import graphical elements from the vendor's catalogs, which may be stored, for example, in the third party servers 140.

The management tool 124 also enables users to inspect, copy, rename or delete existing graphics templates. The management tool 124 enables portable archiving of compositions, which allows users to share their compositions with other users.

The content-builder tool 125 allows users to recall a graphics template, insert text, perform any configuration and save it in the database, such as the database 150, to be recalled later for additional editing or for use within the deployment tool 126. With the content-builder tool 125, compositions may be presented to the user, as the composition would appear during production. The user may select available text fields, image and video placeholders for filling in where appropriate. Once the graphics template has been prepared to the user's satisfaction, the user may save it to the system's database (for example, database 150), where it can be used within the deployment tool 126 for production.

The deployment tool 126 allows for sequencing and playback of previously filled-out graphical templates. In some implementations, the user accesses graphics templates in a dedicated folder tree structure and adds them to a playlist, located on the other side of the screen. Once graphics templates have been added to the list, they may be reordered, renamed and removed at any time.

The user can use the arrow keys to change the selected graphics template and, once the selection has been made, can then choose to recall and send the selected graphic template to an assigned output, which may be, for example, the content hosting server 160. The user can preview the graphics template for quality control and make any changes before sending it to the assigned output. When the graphic template is deployed, it is sent to a previously configured rendering engine for output.

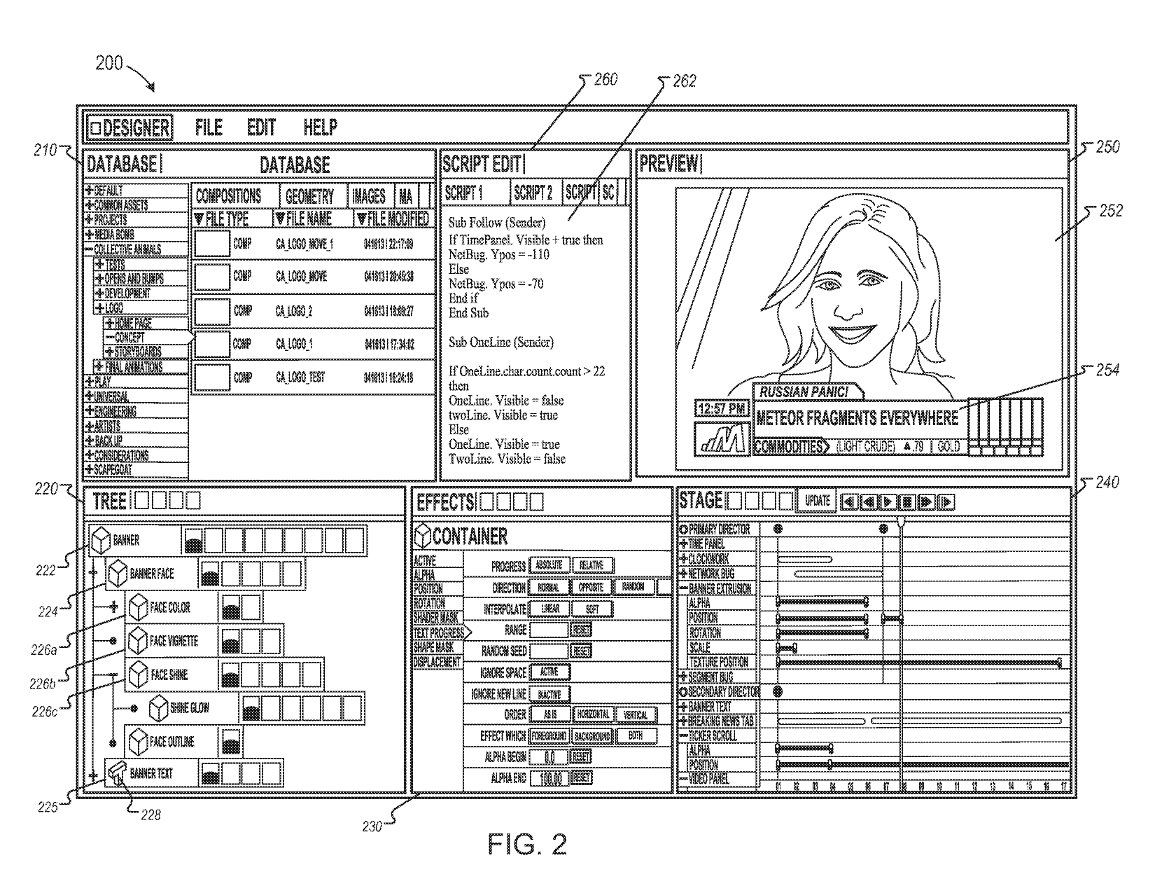

FIG. 2 illustrates an example user interface 200 showing a creation environment that may be used for web-based media content creation. The user interface 200 may be similar to the user interface 128 included in the software tool 112. Accordingly, the following sections describe user interface 200 with respect to the components of the software tool 112. However, the user interface 200 also may be implemented by other software tools or system configurations. In the following sections, “user interface” and “creation environment” are used interchangeably to refer to the user interface 200, which provides a representation of the creation environment for web-based media content creation.

The creation environment enables users to author their compositions by using the rendering engine 122 through the graphical user interface 200. In this context, a composition may comprise a graphical template, which includes two-dimensional (2D) and two-dimensional (3D) geometries, typographical fonts, images, audio clips, video clips, or any suitable combination of these. Any of these elements may be either animated or static.

The user interface 200 includes one or more panels, such as a database panel 210, a parameters editor panel 220, an effects panel 230, an animation panel 240, a preview panel 250 and a script edit panel 260. Each panel may include multiple user interface elements.

A user of the software tool 112 may save and recall compositions at any time, for example using the database panel 210. The compositions may be saved in the database 150, or some other suitable storage that is accessible to the host device running the software tool, such as the host device 110.

The user also may save a specific portion(s) of any composition as an object, which can be shared with other compositions. A composition may include insert graphics (i.e., content which is laid over video), an interactive presentation, a virtual studio, a template for a social media post, or content to be featured in an embedded system found in an kiosk, appliance, vehicle, among others.

In some implementations, the user constructs his or her composition using a hierarchical tree view in the user interface 200. The tree view is shown using the parameter editor panel 220. Some or all of the aforementioned graphical elements may be represented as nodes in the tree view, such as “banner” node 222, which may be associated with the banner graphical element 254 in the preview panel 250.

Nodes may be organized as siblings under a shared parent node, in which they inherit certain properties (e.g., position, scale, rotation, opacity, among others) from any node above them within this hierarchy. The nodes may bear attributes that are available for editing by the user. For example, the banner node 222 may include attributes 224 and 225, which correspond to the banner face and banner text, respectively. The attributes may be represented as icons, for example, icon 228 associated with the attribute 225.

Once a user selects a particular attribute on any node, all available parameters for the selected attribute may be displayed in the parameter editor panel 220. For example, upon user selection of the attribute 224, the parameters “face color” 226a, “face vignette 226b” and “face shine” 226c are displayed on the parameter editor panel 220.

In some implementations, when a user adds an image (also referred to as texture in this context) to a tree node, pressing the appropriate node icon in the parameter editor panel 220 will present the effects panel 230 to the user. In the effects panel 230, the user can bring in additional images and connect them to different types of effects (e.g. additive blending mode, color value adjustment, masking filters, etc.), which allows to build dynamic visual effects.

Once a given node's parameters are visible in the editor panel 220, the user has the option to animate any of these parameters. The user may drag the desired parameter into the animation panel 240, select a point in time, set a value for the parameter's keyframe, select a different point in time and set a different value for the same parameter, and commit it to a keyframe. Now, when the animation is played back (for example, by pressing “start” transport control button), the animated attribute plays back in the manner it was set to during the keyframing process.

The user also may incorporate modifier functions in his or her compositions to affect various nodes. The user may choose from a library of built-in modifiers or generate his own. For example, the user may select modifiers from a database that is accessed through the database panel 210. In some implementations, certain modifiers may affect tree nodes (e.g., alignment of geometries, create clones of geometries, etc.) while other modifiers may affect members in the effects graph. The software tool 112 is highly extensible and may be customized by the user, allowing the user to develop his or her own modifiers and effects by using JavaScript within the creation environment.

The graphics template created by the user is viewable in the preview panel 250. For example, the user may generate a template using a third party video feed on which is overlaid a banner created by the user using the banner node 222. An image 252 corresponding to the third party video feed is shown on the preview panel 250 along with a banner 254 that is associated with the banner node 220.

As the user edits the graphics template, the preview is also updated. For example, as the user modifies various attributes of the banner node 222, the banner 254 shown in the preview panel 250 is updated based on the user modifications.

In some implementations, the software tool 112 includes features to attach code and events to any node in the tree and fire these script code and events from the timeline, when the playback “head” has crossed it's keyframe during the course of playback of the composition. The code may be written in JavaScript, Perl, Python, C, C++, HTML, XML, or some other suitable language.

The user may edit the source code using the script edit panel 260. For example, upon user selection of the banner node 222, the corresponding JavaScript code 262 may be shown in the script edit panel 260. The user may edit the code 262, which would result in modification to one or more attributes of the banner node 222, such that the appearance, or behavior, or both, of the banner 254 is updated.

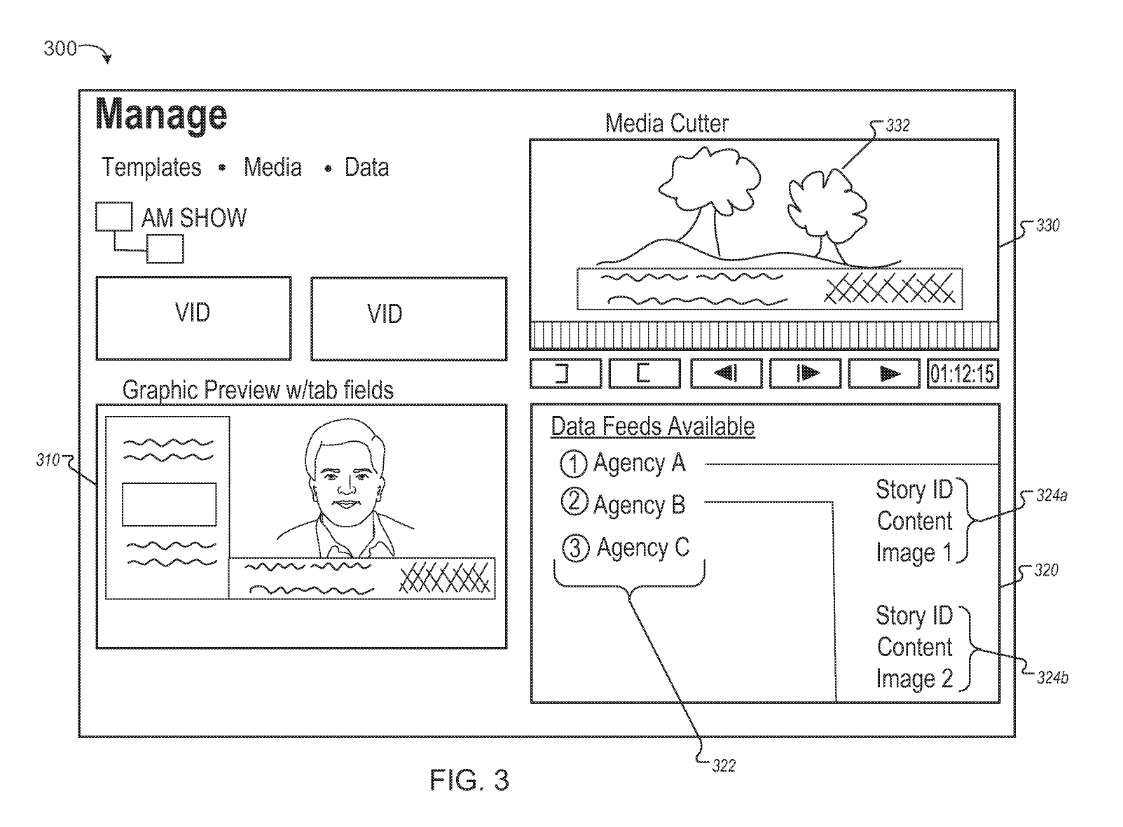

FIG. 3 illustrates an example user interface 300 showing a management environment that may be used for web-based media management. The user interface 300 may be included in the software tool 112 in addition to the user interface 128, or the user interface 200. Accordingly, the following sections describe user interface 300 with respect to the components of the software tool 112. However, the user interface 300 also may be implemented by other software tools or system configurations.

The management environment enables users to manage disparate media content, which may have been authored using the rendering engine 122 through the graphical user interface 200, or sourced from third parties, or both.

The user interface 300 includes one or more panels, such as a graphics preview panel 310, feeds panel 320 and a video preview panel 330. Each panel may include multiple user interface elements.

The user may load media content, such as a graphics template or an image, and preview it using the graphics preview panel 310. The media content may be available from local storage coupled to the machine hosting the software tool 112, such as the database 150. Alternatively, the media content may be available from remote sources that are accessed via a network, such as the third party servers 140.

In some implementations, the feeds panel 320 provides information on the remote sources from which content may be accessed. For example, the feeds panel 320 may display names of third party sources 322 that are accessible by the software tool 112 for data.

The feeds panel also may provide information on the data feeds (i.e., streaming data or other content) available for each remote source. For example, third party source “Agency A” may have available feeds displayed as 324a, while third party source “Agency B” may have available feeds displayed as 324b.

The user may load media content, such as a video or audio clip or a data feed, and preview it using the video preview panel 330. The media content may be available from local storage coupled to the machine hosting the software tool 112, such as the database 150. Alternatively, the media content may be available from remote sources that are accessed via a network, such as the third party servers 140. For example, the media content 332 shown on the video preview panel 330 may be the feed 324a that is accessed over the network (e.g., network 130) from the third party source “Agency A.”

In some implementations, the media content 332 may be a combination of content obtained from disparate sources. For example, the media content 332 may include a video feed obtained from a third party source, along with a graphics template or image overlaid on the video feed that is obtained from local storage.

In some implementations, the video preview panel 330 may provide the user options to edit the media content 332 shown using the panel 330. For example, there may be user input options (such as buttons) that allow the user to trim the displayed data feed, reposition a graphics template overlaid on the data feed, merge two or more data feeds into a single video or audio clip, or perform some other suitable operation.

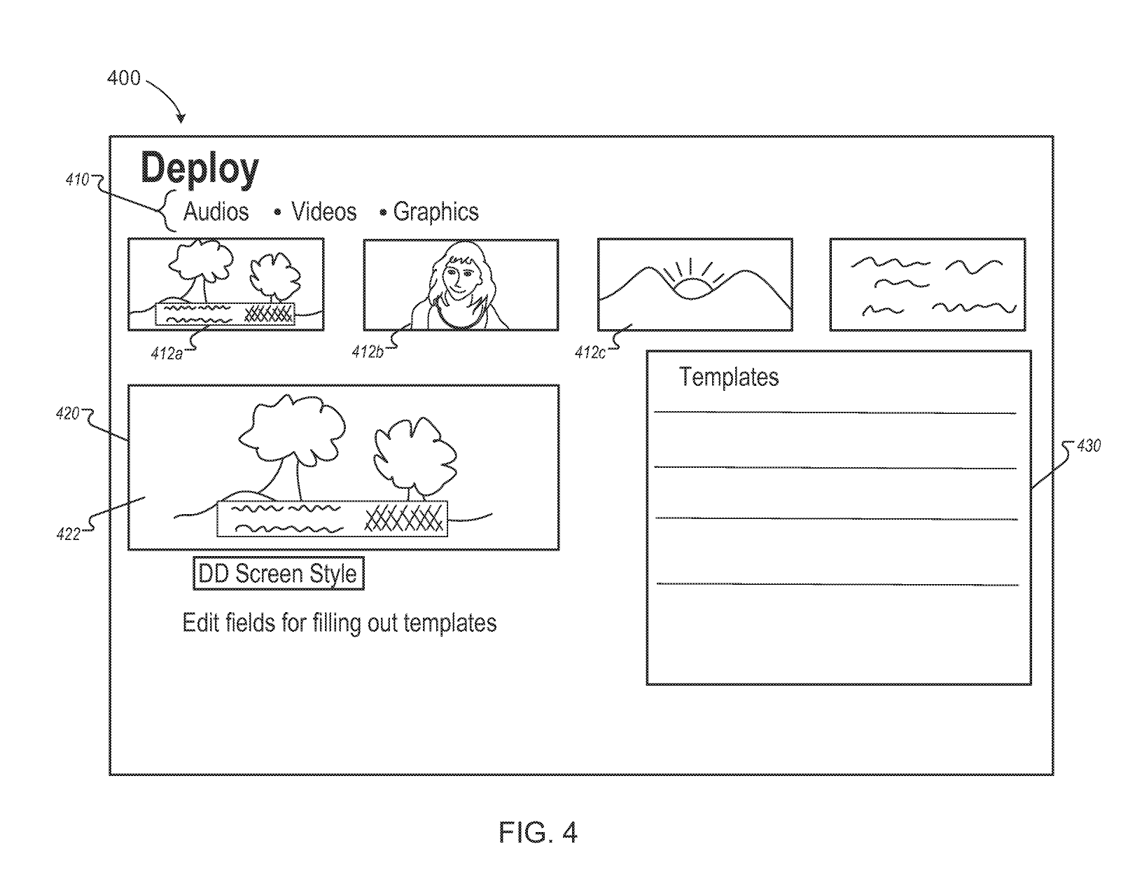

FIG. 4 illustrates an example user interface 400 showing a deployment environment that may be used for deploying media content. In this context, deploying media content refers to broadcasting the media content using one or more means, such as television broadcast, cable transmission, web-based broadcast, or some other suitable broadcast format. In addition, deploying media content may refer to transmission of media to service providers or the like for broadcast, or storage, or both.

The deployment environment enables users to deploy disparate media content, which may have been authored using the rendering engine 122 through the graphical user interface 200, or sourced from third parties, or both.

The user interface 400 may be included in the software tool 112 in addition to the user interface 128 or 200, or the user interface 300, or any suitable combination of these. Accordingly, the following sections describe user interface 400 with respect to the components of the software tool 112. However, the user interface 400 also may be implemented by other software tools or system configurations.

The user interface 400 includes one or more content sources 410, previewed content thumbnails 412a, 412b and 412c, preview panel 420 and templates panel 430. Each panel may include multiple user interface elements.

The user may load media content, such as an audio clip, or video clip, or a graphics template, from one of the sources 410. The loaded media content may be previewed using the preview panel 420. Some of the content that have been previously loaded and previewed may be displayed as the thumbnail images 412a, 412b or 412c. In some implementations, the thumbnail images may display only the last N (where N is an integer) loaded and/or previewed media content. For example, N may be four such that thumbnail images of the four most recent media content that have been loaded and/or previewed are provided in the user interface 400, as shown.

The media content may be available from local storage coupled to the machine hosting the software tool 112, such as the database 150. Alternatively, the media content may be available from remote sources that are accessed via a network, such as the third party servers 140.

In some implementations, one of the thumbnail images may correspond to the media content that is currently previewed using the preview panel 420. For example, as shown, the media content 422 being previewed may be associated with the thumbnail image 412a.

The templates panel 430 provides information on the graphical templates that are available to the deployment environment. In some implementations, the graphical templates shown on the templates panel 430 may be added to audio or video media content while the latter are being previewed using the preview panel 420. In some implementations, the data model, e.g. the media content, in use in the application may support a scene graph to be used for rendering. In a production version, the scene graph may meet the following criteria: designed to conform to existing scene graphs as to be compatible to other tools; designed to express directed graphs and trees; designed to work with a shared model; designed to be decoupled from rendering, such that a conformant rendering representation is computed from the scene graph that can change the rendering model depending on the capabilities of the machine it runs on; designed to support a fine granularity of events with a subscription model for each entity; designed to manage collaboration including conflict resolution.

In some implementations, the user interface described herein, e.g., user interface 200, 300 or 400, may be assembled from inline HTML snippets using jQuery. This may allow for rapid prototyping of new concepts. A production version may use maintainable code; clearly defined interaction patterns; consistent look and feel; flexibility to treat the GUI in different macro contexts/layouts; ability to solve collaboration without impacting the usage of the GUI; clean separation of concerns; and ability to work with a shared model instead of a copied data model. A modular GUI toolkit (similar to Ext.js or Dojo) may be designed, which can accommodate the requirements and defaults to a consistent look and feel, and good interaction patterns.

In some implementations, the rendering engine, e.g., 122, may be designed to structure shader generation, be flexible, or easy to optimize. The model may allow writing arbitrary custom shaders. The render state may be efficiently managed so that user intent is not restricted. The model chosen to render the scene may be decoupled from the scene graph and used as an informing data structure to determine the parameters for rendering. The render state may be able to optimize rendering to the performance of the machine it runs on and use varying existing capabilities to best effect. Additionally, the rendering may be designed to accommodate various post-processing effects (bloom-blur, color/tone mapping, contrast, exposure, etc.)

A range of lighting primitives may be supported by the creation environment (e.g., that represented by the user interface 200), such as: directional lights, point lights, spot lights, sphere lights, line lights, quad lights, box lights, capsule lights, textured lights, and spherical harmonic lights. Additionally, other light-transport methods can also be supported such as, for example, subsurface scattering, blurred shadow maps and transfer maps. In some implementations, global illumination parameters may be supported, including, e.g., irradiance volumes, voxel cone tracing and parallax reflective environment maps. In some implementations, shadowing parameters may be supported, including stencil shadows and shadow maps. Shadow maps may include, for example, exponential shadow maps, variance shadow maps, convolution shadow maps, cascaded shadow maps and horizon-based methods, such as horizon cones, horizon harmonics and pre-computed intervals.

In some implementations, the process to display a video frame in WebGL may include downloading the video frame in YUV color space from VRAM, converting from YUV to RGB by software in the processor of the host device 110, and uploading the video frame from the processor to virtual random access memory (VRAM). In such implementations, the web browser discussed above may perform these steps and data may be routed through multiple processes (e.g., between a tab and the GPU process). In some implementations, a WebGL-specific extension developed by Khronos WebGL Working Group can also be used. The extension may enable rendering arbitrarily sized videos from any video source (WebRTC stream or <video> element) in WebGL with a minimal performance penalty and accurate frame timing.

In some implementations, web browsers used herein, e.g., in the creation environment, may be optimized for the common use case such as the rendering of compressed video at wall-clock time advance. Support for raw video formats without inter-frame compression that could facilitate fast seeking may not be included. In some instances, the creating environment may implement a video decoder for raw video in JavaScript/WebGL (by exploiting shaders to reduce the load of JavaScript). Such features can allow for offline video capture, which covers readily available data in the WebGL context. Additional requirements to capture, store and/or stream video in real-time also may be achieved for reasonably sized videos using WebGL and JavaScript.

The hardware for implementing the application described herein may be dedicated hardware used to support decoding and encoding of video in real-time. In WebGL, a dedicated rendering daemon may be used to support real-time decoding/encoding of vide and offer additional functionality to the application running on that device.

In some implementations, the system may be configured to work with real-time tracking data, including, e.g., producing the tracking data, and/or consuming the tracking data. In such implementations, web browsers may be configured to work with large binary arrays of data (typed arrays) and acquire those arrays from files (e.g., files API). The acquiring may be achieved over the network via TCP/IP (Web sockets) or over the network via UDP (WebRTC data channels).

In some implementations, the server application may be hosted in-memory and may be a simple event router. The application may integrate with a robust-persistence backend and implements collaboration conflict resolution. In addition, secure sockets layer (SSL) may be used to punch through proxies and is designed to accommodate the workflows present in businesses.

Asset management in the application described herein may be done per composition, or implemented as a model suitable to serve multiple compositions. Asset management is configured to edit assets independently of compositions, and supports different formats.

The format of image files that may be supported include, among other suitable formats, JPG, PNG, GIF, TIFF, JPEG 2000, WEBP, RGBE, IFF-RGFX, BMP, CANON/NIKON RAW, OpenEXR and HDRi. In some implementations, alpha pre-multiplication may be available. Gamma for assets may arrive at a consistent way to import images into high quality linear space and support for sRGB profiles may be present.

The formats supported for meshes and scenes in the application described herein may include all variations of OBJ, 3DS, BLEND, Collada, C4DXML, milkshape, md2/3, DXF, X and PLY. Import of data into the application may include both mesh imports and entire scene imports.

The application can support pre-rendered bitmap fonts, and other common font formats, such as TTF/OTF. The application can support Unicode and may include a vector shape rasterizer and a tessellator for 3D fonts. The application can accommodate large texts by texture compression schemes such as perfect spatial hashes.

Scripting for the application may be based on self-contained scripts attached to the scene graph. The application may implement multi-syntax support, such as Vanilla JavaScript, CoffeeScript, Livescript, heap.coffee, Typescript, Coco, C, Mandreel, NSBasic, Go and Actionscript. The application also may include library support.

In some implementations, the application may be available on a website. In addition, the application may be distributed via Apple iOS online app-store using, e.g., a compiler (such as impact.js, AppMobi, Phonegap, Titanium); via Google Play Store; or via Mozilla Marketplace. In some implementations, the application may be available as desktop application, e.g., via Node-Webkit, Google Chrome-packaged applications, or as a desktop app via Mozilla XUL runner. The rendering part of the application may be installed on a rendering machine without a GUI frontend, for example as a separate daemon based on node.js and an OpenGL binding. This may provide rendering of high quality real-time video on special graphics cards.

Other features of the application may include, for example, integrated image editor, integrated mesh modeler, light environment designer, traditional renderer (path/ray tracer), skeletal animation, mesh blending animation, skinning editor, inverse kinematics/physics, processing script support, renderman shade tree support, integrated material editor, procedural materials/textures, procedural (fractal, 1-system based) geometries, and/or audio mixing/rendering support.

The management of assets of the application may be located in any pre-determined location in the viewport and can provide all the primitives available for proper functionality.

The geometries supported by the application may contain arbitrary polygonal models. An import function from OBJ files may be supported. Bodies may be parameterized procedural bodies, which can include, sphere, which may be parameterized by radius and subdivisions; cylinder, which may be parameterized by height and radius, segments and caps; and box, which may be parameterized by width, height and depth.

Such prototype examples of the application may include rendering capabilities that include modifiers to work with render setups. The modifiers may comprise, among others, perspective, which is a perspective projection mode parameterized by field of view; and framebuffer, which includes a deferred render target modifier to achieve off-screen rendering.

Modifiers included in the example prototype of the application may control various behaviors of the scene graph. Such modifiers may include translate, which is a translation modifier that can shift the coordinate system by XYZ; scale, which is a scaling modifier that can scale the coordinate system by XYZ; rotate axis, which is a rotation around an axis (XYZ) by an amount (in degrees); alpha, which sets the alpha blending factor; blend, which sets the blending mode; culling, which sets the culling mode (e.g., none, front, back or both) used to reject triangles during rendering; depth, which modifies the depth write/test functionality (can toggle each on or off); Lambert, which includes a lighting modifier implementing the per-pixel Lambertian model; Blinn-Phong, which is a lighting modifier implementing the per pixel Blinn-Phong model; Heidrich-Seidel Anisotropic, which is a lighting modifier implementing the Heidrich-Seidel Anisotropic model; material, which controls the material channels of an object through a color and texture for the emissive, diffuse and specular channels; envmap, which adds a diffuse and specular environment map influence (equi-rectangular) to rendered objects; directional light, which provides the source for a directional light to any lighting calculation; wireframe, which modifies the shading to draw the object as a wireframe; and mask, which allows masking of the rendering by referencing an off-screen render target.

The images category in the example prototype of the application described herein holds all imported image maps. Image formats supported include PNG, JPEG and GIF. The font category in the example prototype of the application described herein holds all imported fonts, which include bitmap fonts with an application specific file format. The scripts category in the example prototype of the application described herein holds some default scripts, and any imported scripts. The default scripts present include an empty script; and a bar chart script, which works using a font in the composition.

The application may run on a simple scene graph. The scene graph may be controlled from the parameters editor panel 220 in the user interface 200. A user may interact with the parameters editor panel 220 in several ways such as, for example, by dragging a node asset onto the parameters editor panel 220; adding a grouping node; copy a node; delete a node; adding a new child to a node directly from the assets; adding a new modifier to a node directly from the assets; reordering and applying different nesting of the tree by drag and drop; hiding/showing a node and its children; and selecting a node to show its attributes/modifiers in the parameter editors panel 220, the effects panel 230 and/or the edit panel 260. Modifiers can be added to nodes by either dropping them in the parameters editor panel 220 onto nodes, or by dropping them in the attributes panel into the modifier list. In one implementation, modifiers can be added by either dropping them in the parameters editor panel 220 onto nodes, or by dropping them in the attributes panel into the modifier list. Modifiers may be sorted by drag and drop, or discarded by dragging them into the “Remove Mod.” slot.

Attributes may be present in nodes and modifiers, and shown, e.g., in a portion of the parameter editor panel. Numeric input fields can be dragged on to modify their values, or focused for manual entry of values. Each attribute supports resetting its value to the default (brush icon). Vector types support “linking” of their values so that they can be scaled locked to each other by proportional change. Types of attributes supported include, for example: Float; Vec2: 2 component vector field; Vec3: 3 component vector field; RGB: 3 component color field, represented as a colored square, on changeable through a color picker; Bool: Boolean field, represented by a checkbox; text: Text field, represented by an input area; Source: Scripting source editor; select: option selection represented by a dropdown select; Image: Image slot supporting drag and drop of images from the assets and clicking to get an image dropdown; and Noderef: a reference to another node in the tree, represented by a dropdown of the scene tree with nodes greyed out that can't be fitted into this slot (filter by node type). Some attributes may be animated, for example, by dragging the attribute title into the animation panel 240 onto a composition.

In some implementations, a composition, and/or components of a composition, may be referred to as directors. In some implementations, keyframed animation in the application may be supported by an array of individual directors in the animation panel. To create an animation track for an attribute in a composition or director, a user may drag and drop an attribute title onto the director. Animation in a director can support the following features: scrubbing through time by dragging the time mark, or the scrub track; changing time of a director by editing the time code field, or dragging on the components of the time code field; adding a new director; removing a new director (shredder icon); selecting a director (with any interaction in that director); playing a director by the play icon, or by pressing space; pausing a director by (play substituted by pause icon), or by pressing space; rewinding a director to zero (rewind icon); setting a keyframe on a selected track at the current time of the director; setting an event frame on the event on the event track; selecting a keyframe; change a frame's time by dragging it, or dragging on the frame's time code or editing the frame's time code; changing the values of a selected keyframe analogous to how they are changed in attributes; changing the interpolation function of a keyframe to any of linear, ease in/out/in-out to the power of 2, 3, 4 and 5 or by sine, as well as bounce, swing, in/out/in-out and elastic; and delete an animation track.

The primary representation of rendering may be performed in the user interface panel. Rendering supports all the scene graphs modifiers and node types. Additional functionality may include, for example: dynamically resize the preview viewport to the panel size; play a video or the webcam in the background of the viewport; display the bounding box of a selected renderable node; render the composition to video (uncompressed “webm”); and set the compositions resolution.

Compositions may be persisted in different ways such as saving/loading from file or be used on an interactive real-time server. In load/save, the application may support saving out a composition including all its assets and history to a save file (zip format). The same format may be used to load a composition back in. In some implementations, in real-time collaboration, a session may be opened onto a remote server that allows multiple participants to modify the same composition in real-time. The composition is persisted on the server, and it may be possible to “load in” save files into those sessions. Assets (such as fonts, images and meshes) may be streamed to all participants of the session either upon entry to the session, or at such a time when the assets are added to the session. Playback of the composition may be synchronized for all participants in the session, such that a shared playback experience may be facilitated.

The application may be provided either as the full editor, or as a standalone player with minimal controls. The standalone player may support: session connection; loading from file; auto-connecting to a session (URL parameter); auto-loading a file (from URL); minimal playback UI; autoplay of the default director (banner demo); and engaging fullscreen mode. All modifications to a composition by a user may be logged in the compositions history and can be undone or redone. The compositions history is persisted with the saved file, and is present again after loading.

The application may support scripting by creating script nodes in the scene graph. Scripts may include the following features: implementation language is CoffeeScript; compiled from CoffeeScript to JavaScript; executed as JavaScript; global variable sandbox to avoid typo errors introducing undesirable side effects with the application; syntax highlighted source editor; debug console for each script; display of script log entries in the debug console; display of error tracebacks in the debug console; tracebacks are translated to the CoffeeScript source locations; and/or traceback lines that are clickable for take the user to the position in the script for that line.

Script logs may support display of any JavaScript data structure, in abbreviated form if exceeding log limits. In case of multiple identical log entries being made, only one log entry is created, whose incident number counts up. A script may be executed in the renderer. On script error, the script may be halted and an error indicator is shown in the tree view panel. On compile, a script may be instated (or reinstated again). On composition load/open from sessions, scripts may be executed after the rest of the composition has loaded. Custom “control” attributes may be added to a script.

Scripts can interact with a compositions assets, scene graph and directors including: querying/copying/control of a script node's children; querying of a script node's attributes; querying/control of directors; and creating new nodes/modifiers from assets. In some implementations, when a script is stopped, all assets it has created are automatically cleaned up. A script can react to default events (such as when it is to be rendered, when directors play/pause/change time, when its attributes change and so forth. A script can also react to custom events (from the director's event track).

The application may implement performance tracking features, in which the menu bar displays a variety of statistics to help a user keep track of the performance of a composition. The statistics may include, among others: session, which displays network latency when connected to a network session; JS, which is the measured execution time of JavaScript that happens in between the start of a render frame and the end; FPS, which is the measured frame rate, measured by the delay from one frame to the next; total VRAM, which is the total estimated virtual random access memory (VRAM) use; texture VRAM, which is the estimated texture use of VRAM; buffer VRAM, which is the estimated use of VRAM by vertex data; shader count, which is the amount of shaders in use; texture count, which is the amount of textures in use; and/or buffer count, which is the amount of buffers in use.

Scripting may supported in the application by adding script nodes to the tree and editing the scripts with the provided editing widget. Scripts can manage a variety of tasks in the application trough an API that is provided. Scripts may be written in CoffeeScript and support all constructs supported by CoffeeScript 1.6.3. New scripts can be added to the assets database by dragging files with the extension “.coffee” into the asset database. In some implementations, default scripts may be provided, e.g., an empty script and/or a bar chart script. A new script can be created in the tree by dragging a script from the assets either into the tree panel header, or onto the droppable slot of nodes. Scripts may be compiled when a script is added to the tree; when the user hits the “compile” button of a script; when a file containing scripts is loaded; when the user joins a network session containing scripts in the tree; or when the user is in a network session and a script is added remotely.

The scripts may be executed in the context of the renderer component. In some implementations, the scripts may interact indirectly with the UI component, the history component or networked sessions. In some implementations, a script is aborted in case of error and has to be compiled or executed again in order to restart. The script code is evaluated at each compile and the old script context including all its acquired resources (if any) are discarded in the renderer. In some implementations, scripts interact with the application through a set of APIs, as described in the following sections.

One API may be the script object—a script has access to its own context with the variable “script” which is the entry point for most other functionality. Scripts can react to events in the application by using the “script.on” API. For example, “script.on ‘render’, ->script.log ‘render of this node’.”

Default events may be predefined. These may include: render, which is called when it is time to render the script node; script-init, which is emitted when the script is started; script-stop, which is emitted when a script is stopped; director-play event, which is emitted when a director starts playing; director-pause event, which is emitted when a director is paused; and director-set-time event, which is emitted when a directors time is set.

In some implementations, the director or composition may be represented by an event object, which may be referred to as a director event object (or director object). The director event object may include multiple members, e.g., director, which is an object used to communicate with the composition, and/or data, which is the time of the event. In addition to the default events, a script also can react to event keyframes as defined in directors. For example, “script.on ‘example-event’, (event) script.log event.” The director event object is the originating director, but the data member is filled from the event keyframes data text.

Directors can be accessed through the “script.directors( )” API which returns a list of all currently defined directors. Additional director objects can also be obtained from director events (play, pause, set-time) or custom event keyframe events “.director” member. Director objects may support the following APIs: Member identification (ID), which returns this directors unique ID; Method title( ), which returns the current director title; Method pause([time]), which pauses the director, optionally at the given time; Method play([time]), which plays the director, optionally at the given time; and Method setTime(time), which sets the time of the director.

Scripts can acquire custom attributes to control their behavior. The user can add attributes by pressing the button “add attribute” in a parameter editor panel. The user can obtain an instance of an attribute by calling “script.attrib(‘my-attribute’),” where “my-attribute” is the name of the attribute the user entered when the user created the attribute. The attribute is updated from the current values (also when they're animated) and/or members may be accessed depending on type, which includes Float: .value; RGB: .r, .g and .b; Vec3: .x, .y and .z; Vec2: .x and .y; Text: .value; Bool: .value; Image: .value; and Noderef: .value;

The user can also be notified of changes in attributes using, for example, “script.onAttribChange ‘my-attribute’, (value)->console.log value,” where value is either a single value, or a list (in case of vector types or color). The user can query assets from the database with the following function: “quad=script.queryAsset(type:‘geometry’, title:‘Quad’)[0].” In response, a list of assets may be returned. The arguments, which are filters on what assets the user will obtain, may include type: the type name the user wants to filter for; and title: the title for which the user wants to filter.

Once the user has obtained an asset, the user can use it to create a node with the “createNode” API: “quadNode=script.createNode quad.” The user can create modifiers with the createModifier API, for example “myMaterial=script.createModifier ‘material’.” The user can then append the modifier to a node using “quad.appendModifier myMaterial.”

Both nodes and modifiers may carry attributes the user might want to change. The user can access these attributes from the “attribs” member of nodes/modifiers using myMaterial.attribs.diffuseColor.set([1,0,1]).” Modifier attributes may include: translate (pos: vec3); scale (pos: vec3); rotateAxis (axis: vec3, angle: float); alpha (alpha: float); blend (blend: select (none/alpha/additive/multiply)); culling (side: select (none/back/front/both)); depth (write: bool, test: bool); lambert (diffusePower: float; specularPower: float); blinnPhong (diffusePower: float, specularPower: float); heidrichSeidel (diffusePower: float, specularPower: float, anisotropicPower: float); material (scale: vec2, offset: vec2, emissiveColor: rgb, emissiveTexture: texturelD, diffuseColor: rgb, diffuseTexture: texturelD, specularColor: rgb, specularTexture: rgb); envmap (diffuseTexture: texturelD, specularTexture: texturelD); light (color: rgb, elevation: float, orientation: float); wireframe (enabled: bool); and mask (node: nodeID, invert: bool).

Node attributes may include: box (size: vec3); cylinder (radius: float, height: float, segments: float, caps: bool); sphere (radius: float, subdivisions: float); text (align: select (left/center/right), valign: select (baseline/top/middle/bottom), size: float, letterSpace: float, lineSize: float, text: text); perspective (pos: vec2, size: vec2, fov: float); framebuffer (active: bool); and script (source: text).

Scripts also may have access to nodes, either by creating the nodes or by querying the nodes from the render model using, for example, “thisScriptsNode=script.node.” Nodes may support the following APIs: member .id, which is the unique ID of this node; member .children, which is a list of the child nodes; member .modifiers, which is a list of modifiers; member .attributes; member .visible, which is Boolean if the node is rendered; member .title, which is the title of this node; method .copy( ), which creates a copy of the node for use by the script; method .destroy( ), which deletes the node; method appendChild(child)/prependChild(child), which adds a child to the node; method appendModifier(modifier), which adds a modifier to the node; method render( ), which renders the node; and setVisible(true/false), which sets the nodes visibility. Additional text nodes supported may include method setText(text), which sets/layouts the text nodes text.

Scripts may have direct access to the render state stack, which may be useful to simplify/optimize rendering without having to create a set of modifiers. The state stack may be accessible through the variable “script.stack.” Stack entries can be pushed and popped, and these calls may be balanced, for example:
script.stack.push( ).translate(1, 0, 0)
   somenode.render( )
   script. stack.pop( )

The stack may support the following API: push( ): pushes a stack entry; pop( ): pops a stack entry; pushLight(light): adds a light to the stack; setShading(modifier): sets the shading modifier; setEnvmap(modifier): sets the environment map; perspective(fov, aspect, near, far): sets up a projection matrix; translate(x, y, z): translates the model matrix; scale(x, y, z): scales the model matrix; rotateAxis(x, y, z, angle): rotates the model matrix around the xyz axis by angle; viewport(x, y, w, h): sets the viewport to x/y with the dimension w/h; alpha(value): sets the alpha value; blend(value): sets the blend value; cull(value): sets the cull face; depthTest(value): sets the depth test Boolean; depthWrite(value): sets the depth write Boolean; setWireframe(value): sets the wireframe Boolean; and setMask(modifier): sets the masking modifier.

Scripts can access the current time in seconds (which might be different from wall-clock time due to rendering to video), for example using “currentTime=script.now( ).”

In order to obtain outside data to work with, scripts can connect to web socket servers with the “script.connect” API. For example:

connection = script.connect ‘myserver.com/some/path’,

open: −> script.log ‘connection opened’
close: −> script.log ‘connection closed’
message: (data) −> script.log ‘message received’, data

The glint server supports a watchfile API that may be accessed on the path “/watchfile/myfile.txt”. The watchfile API may be used to receive updates whenever the file in that directory on the server has changed.

The following section provides an example implementation of a script written against the script API. The script shown below is an example only, and is not intended to be a limitation. In other instances, any other suitable implementation of a script is possible.

In one implementation, the bar chart script interacts with the assets to obtain a font to draw labels. The bar chart script parses a custom attributes content to obtain the values to display and interacts with other attributes to set the color for text and bars as well as the chart caption.

quad = script.queryAsset(type:‘geometry’, title:‘Quad’)[0]
box = script.queryAsset(type:‘box’)[0]
font = script.queryAsset(type:‘font’)[0]
if font?

reveal = script.attrib(‘reveal’)
textColor = script.attrib(‘textColor’)
barColor = script.attrib(‘barColor’)
textMaterial = script.createModifier ‘material’
barMaterial = script.createModifier ‘material’
values = script.attrib(‘values’)
parseValues = (values) −>

entries = values.trim( ).split ‘,’
result = [ ]
for entry in entries

entry = entry.trim( )
if entry.length > 0 and ‘=’ in entry

item = entry.split ‘=’
if item.length == 2

[label, value] = item
label = label.trim( )
value = parseFloat(value.trim( ))
if label.length > 0 and not isNaN(value)

result.push label:label, value:value

return result

class Bar

constructor: (label, value, width, height, offset) −>

@bar = script.createNode box
@bar.appendModifier barMaterial
@label = script.createNode font
@label.appendModifier textMaterial
@label.attribs.size.set 0.003
@value = script.createNode font
@value.attribs.size.set 0.003
@set label, value, width, height, offset

render: −>

height = @height*reveal.value
script.stack.push( )

.translate(@offset, height-0.75, 0)
.scale(@width, height, @width)
.depthTest(true)
.depthWrite(true)
.cull(‘back’)

@bar.render( )
script.stack.pop( )
script.stack.push( )

.translate(@offset, height*2-0.55, 0)
.depthTest(true)
.depthWrite(false)

@value.render( )
script.stack.pop( )
script.stack.push( )

.translate(@offset, −1, 0)
.depthTest(true)
.depthWrite(false)

@label.render( )
script.stack.pop( )

set: (label, value, @width, @height, @offset) −>

@label.setText label
@value.setText value.toFixed(0)

destroy: −>

@bar.destroy( )
@label.destroy( )
@value.destroy( )

bars = [ ]
updateChart = (values) −>

for bar in bars

bar.destroy( )

values = parseValues(values)
max = values[0].value
for {label, value}, i in values

max = Math.max(value, max)

bars = for {label, value}, i in values

offset = (i/(values.length−1))*2-1
width = 1/values.length
height = value/max
new Bar(label, value, width, height, offset)

updateChart(values.value)
script.onAttrChange ‘values’, (values) −>

updateChart( values)

caption = script.attrib(‘caption’)
captionNode = script.createNode font
captionNode.appendModifier textMaterial
captionNode.setText caption.value
captionNode.attribs.size.set(0.005)
script.onAttrChange ‘caption’, (value) −>

captionNode.setText value

isLit = −>

haveShading = false
for modifier in script.node.modifiers

if modifier.isShading( )

haveShading = true
break

if script.stack.lightCount( ) > 0 and haveShading

return true

else

return false

script.on ‘render’, −>

if isLit( )

barMaterial.attribs.emissiveColor.set([barColor.r*0.05,barColor.g*0.05,barColor.b*0.05]
)
textMaterial.attribs.emissiveColor.set([textColor.r*0.05,textColor.g*0.05,textColor.b*0.0
5])
barMaterial.attribs.diffuseColor.set([barColor.r,barColor.g,barColor.b])
textMaterial.attribs.diffuseColor.set([textColor.r,textColor.g,textColor.b])

else
barMaterial.attribs.emissiveColor.set([barColor.r,barColor.g,barColor.b])
textMaterial.attribs.emissiveColor.set([textColor.r,textColor.g,textColor.b])
script.stack.push( )

.alpha(reveal.value)
.translate(0, −0.25, 0)
.scale(0.6, 0.6, 0.6)

for bar in bars

bar.render( )

script.stack.push( )

.depthTest(true)
.depthWrite(false)
.translate(0, 1.8, 0)

captionNode.render( )
script.stack.pop( ).pop( )

The ticker script uses the websocket API to obtain a symbols file from the server and watch for any changes. The ticker script parses the file and uses the node copy API to create ticker items from its child node, hence making the children act as a ticker items template.

templates = { }

for child in script.node.children

templates[child.title] = child
child.setVisible(false)

class Entry

constructor: −>

@symbol = templates.symbol.copy( )
@price = templates.price.copy( )
@trend = templates.trend.copy( )
@visible = false

set: ({symbol, price, trend}) −>

@symbolText = symbol
@priceValue = price
@trendValue = trend
if trend > 0

@arrow = templates.up

else

@arrow = templates.down

@symbol.setText(symbol)
@price.setText(price.toFixed(1))
@trend.setText(trend.toFixed(1))
@visible = true

render: (offset) −>

if @visible

script.stack.push( )

.translate(offset, 0, 0)

@symbol.render( )
@price.render( )
@trend.render( )
@arrow.setVisible(true)
@arrow.render( )
@arrow.setVisible(false)
script.stack.pop( )

entries = for i in [0...5]

new Entry ‘SYMB’, 12.3, 0.1

itemWidth = 7
speed = 3
width = entries.length * itemWidth
offset = −width/2
queue = [ ]
symbols = [ ]
script.connect ‘codeflow.org:2500/watchfile/ticker.txt’,

message: (data) −>

symbols = for line in data.trim( ).split(‘\n’)

[symbol, price, trend] = line.split(/\s+/)
price = parseFloat(price)
trend = parseFloat(trend)
symbol = {symbol:symbol, price:price, trend:trend}
for entry in entries

if entry.symbolText == symbol.symbol

entry.set(symbol)

symbol

rotate = −>

entry = entries.shift( )
entries.push(entry)
if symbols.length > 2

data = symbols.shift( )
symbols.push(data)
entry.set(data)

last = script.now( )
script.on ‘render’, −>

now = script.now( )
delta = now − last
last = now
offset −= delta*speed
if offset < −width/2 − itemWidth

offset += itemWidth
rotate( )

for entry, i in entries

entry.render(i*itemWidth+offset)

In one implementation, the presentation script may make use of the director events and API to implement the logic required to go through a presentation one director at a time, which can pause inside a director and when reaching the end of one director, engage the next director. An example implementation is shown below.

directors = script.directors( )

isSlide = (director) −>

return director.title( ).match(/\hat{ }Slide/) != null

directorIndex = (id) −>

for director, i in directors

if director.id == id

return i

findNextSlide = (id) −>

idx = directorIndex id
for director, i in directors

if i > idx and isSlide(director) and director.id != id

return director

currentSlide = findNextSlide directors[0].id
resetNonCurrent = −>

for director in directors

if isSlide(director) and director.id != currentSlide.id

director.pause(0)

script.on ‘advance’, (event) −>

event.director.pause(0)
currentSlide.play( )

script.on ‘next-slide’, (event) −>

event.director.pause(0)
nextSlide = findNextSlide event.director.id
if nextSlide?

currentSlide = nextSlide
resetNonCurrent( )

script.on ‘pause’, (event) −>

event.director.pause( )

script.on ‘director-play’, (event) −>

if isSlide(event.director)

if currentSlide.id != event.director.id

currentSlide = event.director
resetNonCurrent( )

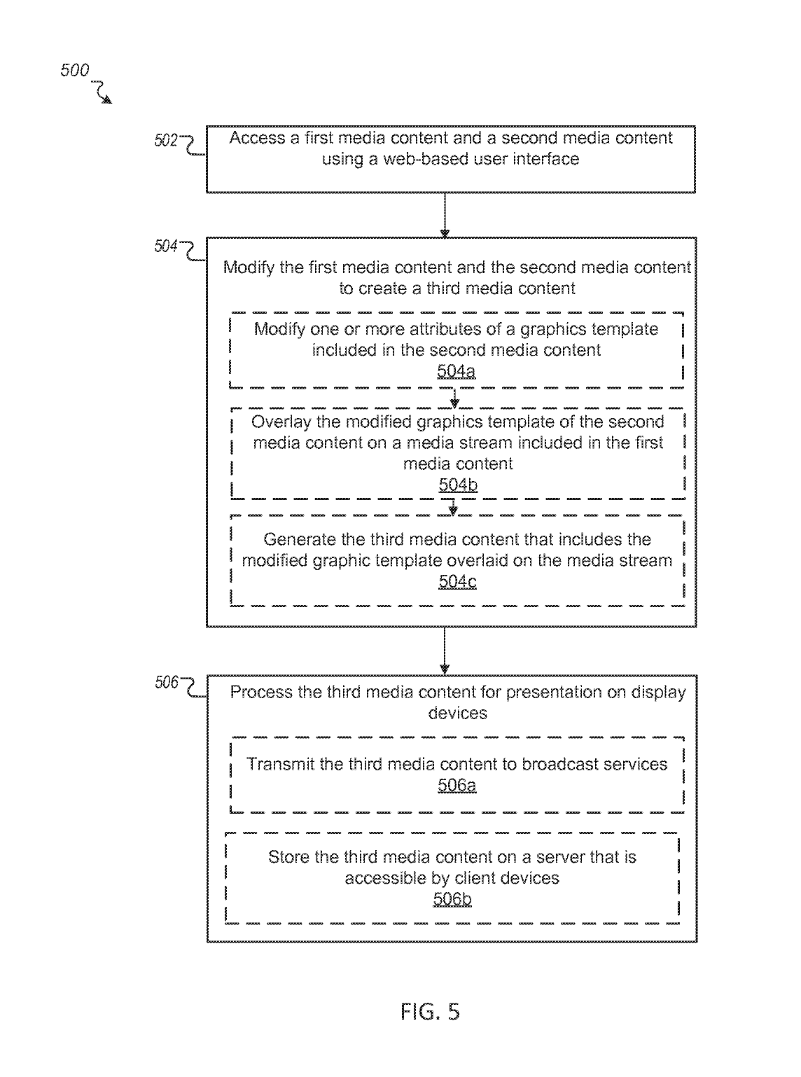

FIG. 5 is a flow chart illustrating an example process 500 for the creation and management of media content using web-based technologies. The process 500 may be used by the host device 110 to create different forms of media content, manage various media content and deploy such media content to a variety of platforms such as, for example, broadcast television, World Wide Web (web), mobile electronic devices and embedded electronic devices. The media content involved in the process 500 may be in the form of, for example, voice, audio, video, graphics, and textual data, among others. Accordingly, the following describes the process 500 as implemented by components of the system 100. However, in other implementations, the process 500 also may be implemented by any other suitable systems or system configurations.

The host device 110 may implement the process 500 using one or more processors, memory, and display (devices) that present user interface(s) 128. The processor(s) may implement the process 500 based on instructions stored in the memory included in the host device. Such instructions can include instructions for implementing various input/output operations, content media creation and modification, instructions for transmitting and storing various content media, and/or the like.

At 502, a first media content and a second media content are accessed using a web-based user interface. In some instances, the first media content and/or the second media content can be accessed from a remote server (e.g., third party server 140) over the network 130. In other instances, the first media content and/or the second media content can be accessed from a local storage device coupled to the host device 110 on which a web-based user interface is executed. In some implementations, the first and second media contents can include, for example, a stock ticker, weather forecast and mapping imagery, on-screen interactive presentations, virtual studios, and may be either animated or static.

In some implementations, the (web-based) user interface is similar to the user interface 128 and is associated with a Web Graphics Library (WebGL) included in the web browser 111 running on the host device 110. The user interface 128 may be coupled to a rendering engine 122 executed on the host device 110, where the rendering engine 122 can utilize WebGL for modifying at least one of the first and the second media contents to create the third media content.

At 504, the first media content and the second media content are modified to create a third media content. For example, the first media content and the second media content can be modified in a creation environment that enables a user to author or modify their compositions by using the rendering engine 122 through the graphical user interface 200. Once a user has authored (or modified) the contents of the first media content and/or the second media content and has published it, the modified media content may be viewed and interacted with via the user interface 128.

The first media content may include a media stream and the second media content may include a graphics template, which can include two-dimensional (2D) and two-dimensional (3D) geometries, typographical fonts, images, audio clips, video clips, and/or any suitable combination of these. In such implementations, modifying the first media content and the second media content can include modifying one or more attributes of the graphics template included in the second media content, at 504a. For example, the graphics template of the second media content may be operable to display live information, such as a stock ticker, a news feed, weather update, an emergency alert, or broadcast program information. Modification of one or more attributes of the graphics template in the second media content can be implemented by the rendering engine 122 through the graphical user interface 200. For example, in some instances, the user can add one or multiple images to the graphics template and connect the images to different types of effects (e.g. additive blending mode, color value adjustment, masking filters, etc.), which can allow to build dynamic visual effects.

In other instances, the user can animate the graphics template by selecting a point in time, setting a value for the parameter's keyframe, selecting a different point in time and setting a different value for the same parameter, and committing the graphics template to a keyframe. In such instances, when the animation is played back, the animated attribute plays back in the manner it was set to during the keyframing process. In other instances, the user can modify the various attributes of the banner node 222 as shown in the graphical user interface 200. In yet other instances, the software tool 112 also includes features to attach code to modify the graphics template such as, for example, codes written in JavaScript, Perl, Python, C, C++, HTML, XML, or any other suitable language.

In some implementations, modifying the first media content and the second media content can include overlaying the modified graphics template of the second media content on a media stream included in the first media content, at 504b. Overlaying the modified graphics template of the second media content on a media stream included in the first media content may be performed by the rendering engine 122 through the graphical user interface 200. For example, in some instances, the first media content may be a video feed obtained from a third party source (e.g., from third party server 140), that may be overlaid with the modified graphics template of the second media content, where the second media content is obtained from local storage. In such instances, the graphical user interface 200 provides the user with options to modify or edit the first media with the second media content.

Modifying the first media content and the second media content can include generating the third media content that includes the modified graphic template of the second media content overlaid on the media stream of the first media content, at 504c. In some implementations, after generating the third media content, the user can access a management environment for web-based management of one or multiple media contents (e.g., the third media content). The management environment enables users to manage disparate media content through a graphical (management) user interface 300. The (management) user interface is similar to the user interface 300 and can include user input options (such as buttons) that allow the user to trim the displayed data feed, reposition a graphics template overlaid on the data feed, merge two or more data feeds into a single video or audio clip, or perform any other suitable operation.

At 506, the third media content is processed for presentation on display devices. For example, the third media content may be processed in a deployment environment used for deploying media content using a (deployment) user interface 400 for presentation on display devices. The deployment environment enables users to deploy disparate media content, which may have been authored (or modified) using the rendering engine 122 through the graphical user interface 200, and sourced from third parties or obtained from local storage, or both.

In some implementations, processing the third media content for presentation on display devices can include transmitting the third media content to broadcast services, at 506a. Examples of such broadcast services can include television broadcast, cable transmission, web-based broadcast, or any other suitable broadcast format. Examples of display devices that can receive the third media content (output content) can include a Thin-Film-Transistor Liquid Crystal Display (“TFT LCD”) or an Organic Light Emitting Diode (“OLED”) display, or other appropriate display technology present in televisions and/or other client devices.

Additionally or alternatively, in some implementations, processing the third media content over a network for presentation on display devices can include storing the third media content on a server that is accessible by client devices, at 506b. In some instances, the third media content may be stored on a storage device (e.g., a hard drive, a memory, etc.) of a third party server that is accessible by the host device 110 and the client devices via the network 130. In other instances, the third media content can also be stored on a local storage (e.g., a database) that is directly coupled to the host device 110 on which the web-based user interface is executing.

The features described can be implemented in digital electronic circuitry, or in computer hardware, firmware, software, or in combinations of them. The apparatus can be implemented in a computer program product tangibly embodied in an information carrier, e.g., in a machine-readable storage device, for execution by a programmable processor; and method steps can be performed by a programmable processor executing a program of instructions to perform functions of the described implementations by operating on input data and generating output. The described features can be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors of any kind of computer. Generally, a processor will receive instructions and data from a read-only memory or a random access memory or both. The elements of a computer may include a processor for executing instructions and one or more memories for storing instructions and data. Generally, a computer will also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory can be supplemented by, or incorporated in, ASICs (application-specific integrated circuits).

To provide for interaction with a user, the features can be implemented on a computer having a display device such as a CRT (cathode ray tube) or LCD (liquid crystal display) monitor for displaying information to the user and a touchscreen and/or a keyboard and a pointing device such as a mouse or a trackball by which the user can provide input to the computer.

The features can be implemented in a computer system that includes a back-end component, such as a data server, or that includes a middleware component, such as an application server or an Internet server, or that includes a front-end component, such as a client computer having a graphical user interface or an Internet browser, or any combination of them. The components of the system can be connected by any form or medium of digital data communication such as a communication network. Examples of communication networks include, e.g., a LAN, a WAN, and the computers and networks forming the Internet.

The computer system can include clients and servers. A client and server are generally remote from each other and typically interact through a network, such as a network described above. The relationship of client and server arises by virtue of computer programs running on the respective computers and having a client-server relationship to each other.

While this document contains many specific implementation details, these should not be construed as limitations on the scope what may be claimed, but rather as descriptions of features that may be specific to particular embodiments. Certain features that are described in this specification in the context of separate embodiments can also be implemented in combination in a single embodiment. Conversely, various features that are described in the context of a single embodiment can also be implemented in multiple embodiments separately or in any suitable sub combination. Moreover, although features may be described above as acting in certain combinations and even initially claimed as such, one or more features from a claimed combination can, in some cases, be excised from the combination, and the claimed combination may be directed to a sub combination or variation of a sub combination.

What is claimed is:

1. A computer program product, implemented in a non-transitory machine-readable medium storing instructions that, when executed by a processor, are configured to cause the processor to perform operations comprising:
accessing, using a web-based user interface, a first media content and a second media content;
modifying, using the web-based user interface, at least one of the first or the second media contents to create a third media content that is based on the first and the second media contents; and
transmitting, using the web-based user interface, the third media content over a network for presentation on display devices.

2. The computer program product of claim 1, wherein accessing the first and second media contents comprises one of:
accessing at least one of the first and second media contents from a remote server over the network, or
accessing at least one of the first and second media contents from a local storage coupled to a computing device on which the web-based user interface is executed.

3. The computer program product of claim 1, wherein the web-based user interface is presented on a web browser running on a computing device.

4. The computer program product of claim 3, wherein the web-based user interface is associated with a Web Graphics Library (WebGL) included in the web browser running on the computing device.

5. The computer program product of claim 4, wherein modifying the first and the second media contents include a rendering engine executed on the computing device and coupled to the web-based user interface, the rendering engine operable to utilize WebGL for modifying at least one of the first and the second media contents to create the third media content.

6. The computer program product of claim 1, wherein the first media content includes a media stream and the second media content includes a graphics template, and wherein modifying at least one of the first or the second media contents to create the third media content comprises:
modifying one or more attributes of the graphics template;
overlaying the modified graphics template on the media stream; and
generating the third media content including the modified graphics template overlaid on the media stream.

7. The computer program product of claim 6, wherein the media stream includes a video feed that is obtained from a remote server over the network.

8. The computer program product of claim 7, wherein the graphics template is operable to display live information.

9. The computer program product of claim 8, wherein the live information is one of a stock ticker, a news feed, weather update, an emergency alert, or broadcast program information.

10. The computer program product of claim 1, wherein the instructions for transmitting the third media content over the network for presentation on display devices comprises instructions that are configured to cause the processor to perform operations comprising one of:
sending the third media content to broadcast television stations, or
storing the third media content on a server that is accessible by client devices via the network.

11. The computer program product of claim 1, further comprising:
storing the third media content in a local storage coupled to a computing device on which the web-based user interface is executed.

12. A system comprising:
a web-based user interface;
a management module including first instructions stored in a first machine-readable medium that, when executed by a first processor, are configured to cause the first processor to perform operations comprising:
accessing, using the web-based user interface, a first media content and a second media content;
means for modifying at least one of the first or the second media contents to create a third media content that is based on the first and the second media contents; and
a deployment module including second instructions stored in a second machine-readable medium that, when executed by a second processor, are configured to cause the second processor to perform operations comprising:
transmitting, using the web-based user interface, the third media content over a network for presentation on display devices.

13. The system of claim 12, wherein accessing the first and second media contents comprises one of:
accessing at least one of the first and second media contents from a remote server over the network, or
accessing at least one of the first and second media contents from a local storage coupled to a computing device on which the web-based user interface is executed.

14. The system of claim 12, wherein the web-based user interface is executed on a computing device, the web-based user interface presented on a web browser running on the computing device.

15. The system of claim 14, wherein the web-based user interface is associated with a Web Graphics Library (WebGL) included in the web browser running on the computing device.

16. The system of claim 15, wherein the means for modifying the first and the second media contents include a rendering engine executed on the computing device and coupled to the web-based user interface, the rendering engine operable to utilize WebGL for modifying at least one of the first and the second media contents to create the third media content.

17. The system of claim 12, wherein the first media content includes a media stream and the second media content includes a graphics template, and wherein modifying at least one of the first or the second media contents to create the third media content comprises:
modifying one or more attributes of the graphics template;
overlaying the modified graphics template on the media stream; and
generating the third media content including the modified graphics template overlaid on the media stream.

18. The system of claim 17, wherein the media stream includes a video feed that is obtained from a remote server over the network.

19. The system of claim 17, wherein the graphics template is operable to display live information.

20. The system of claim 19, wherein the live information is one of a stock ticker, a news feed, weather update, an emergency alert, or broadcast program information.

21. The system of claim 12, wherein the second instructions for transmitting the third media content over the network for presentation on display devices comprises second instructions that are configured to cause the second processor to perform operations comprising one of:
sending the third media content to broadcast television stations, or
storing the third media content on a server that is accessible by client devices via the network.

22. The system of claim 12, wherein the first instructions are configured to cause the first processor to perform operations further comprising:
storing the third media content in a local storage coupled to a computing device on which the web-based user interface is executed.

23. A method comprising:
presenting a web-based user interface using web browser on a computing device;
accessing, using the web-based user interface, a first media content and a second media content;
modifying, using the web-based user interface, the first and the second media contents to create a third media content that is based on the first and the second media contents; and
transmitting, using the web-based user interface, the third media content over a network for presentation on display devices.

24. The method of claim 23, wherein accessing the first and second media contents comprises one of:
accessing at least one of the first and second media contents from a remote server over the network, or
accessing at least one of the first and second media contents from a local storage coupled to a computing device on which the web-based user interface is executed.

25. The method of claim 23, wherein the web-based user interface is associated with a Web Graphics Library (WebGL) included in the web browser running on the computing device.

26. The method of claim 25, wherein the web-based user interface is coupled to a rendering engine executed on the computing device, the rendering engine operable to utilize WebGL for modifying at least one of the first or the second media contents to create the third media content.

27. The method of claim 23, wherein the first media content includes a media stream and the second media content includes a graphics template, and wherein modifying at least one of the first and the second media contents to create the third media content comprises:
modifying one or more attributes of the graphics template;
overlaying the modified graphics template on the media stream; and
generating the third media content including the modified graphics template overlaid on the media stream.

28. The method of claim 27, wherein the media stream includes a video feed that is obtained from a remote server over the network.

29. The method of claim 27, wherein the graphics template is operable to display live information.

30. The method of claim 29, wherein the live information is one of a stock ticker, a news feed, weather update, an emergency alert, or broadcast program information.

31. The method of claim 23, wherein transmitting the third media content over the network for presentation on display devices comprises one of:
sending the third media content to broadcast television stations, or
storing the third media content on a server that is accessible by client devices via the network.

32. The method of claim 23, further comprising:
storing the third media content in a local storage coupled to a computing device on which the web-based user interface is executed.
